(19) United States
(12) Patent Application Publication
(10) Pub. No.: US 2009/0157663 A1
(43) Pub. Date: Jun. 18, 2009

(54) MODELING QUALITATIVE RELATIONSHIPS IN A CAUSAL GRAPH

(75) Inventor: Ten Warner Rudolph Theophile Kate, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: HIGH TECH CAMPUS 44, EINDHOVEN (NL)

(21) Appl. No.: 12/304,216

(22) PCT Filed: Jun. 6, 2007
(86) PCT No.: PCT/IB2007/052119

§ 371 Date: Dec. 10, 2008

(30) Foreign Application Priority Data
Jun. 13, 2006 (EP) 06115357.3

(51) Int. Cl. G06F 7/06; G06N 5/02; G06F 3/048; G06F 17/30

(52) U.S. Cl. 707/5; 706/46; 715/810; 706/52; 707/7; 707/E17.016; 707/E17.045; 707/E17.044; 707/E17.046

(57) ABSTRACT

The invention relates to a system (100, 304) for determining a subset of disorders of a set of disorders for an observed symptom of a set of symptoms, the system comprising: a modeler (102) for modeling qualitative relationships between disorders of the set of disorders and symptoms of the set of symptoms as a causal graph; an orderer (104) for partially ordering the qualitative relationships; a determiner (106) for using the observed symptom to determine the subset of disorders for the observed symptom based upon the partial ordering of the qualitative relationships. The invention further relates to a method of determining a subset of disorders of a set of disorders for an observed symptom of a set of symptoms, wherein qualitative relationships between disorders of the set of disorders and symptoms of the set of symptoms are modeled as a causal graph and the qualitative relationships are partially ordered, the method comprising using the observed symptom to determine the subset of disorders for the observed symptom based upon the partial ordering of the qualitative relationships. The invention further relates to A medical workstation (116) for determining a subset of disorders of a set of disorders for an observed symptom of a set of symptoms, the medical workstation comprising: the system (100, 304) according to the invention; a database (112, 306) comprising a set of disorders, a set of symptoms, a model of qualitative relationships between disorders of the set of disorders and symptoms of the set of symptoms as a causual graph and a partial ordering the qualitative relationships; and an interactive device (118, 120, 122) for providing interaction between a user and the medical workstation. The invention further relates to a computer program product (324) to be loaded by a computer arrangement (116), comprising instructions for determining a subset of disorders of a set of disorders for an observed symptom of a set of symptoms, the computer arrangement comprising processing unit (110) and a memory (124), the computer program product, after being loaded, providing said processing unit with the capability to carry out method according to the invention.

The invention relates to a system for determining a subset of disorders of a set of disorders for an observed symptom of a set of symptoms.

The invention further relates to a medical workstation comprising such a system; a method for determining a subset of disorders of a set of disorders for an observed symptom of a set of symptoms; and a computer program product to be loaded by a computer arrangement, comprising instructions for determining a subset of disorders of a set of disorders for an observed symptom of a set of symptoms.

Decision Support Systems (DSS) may assist their users in reasoning about encountered problems. In medical applications for example, a physician can use a clinical DSS (CDSS), when given a patient's symptoms, to arrive faster at the diagnosis of the disease or multiple diseases, or to obtain a more complete picture of the diseases. The DSS is not limited to as an aid to diagnosis alone. It can also assist in other tasks such as deciding what subsequent tests need to be performed to exclude alternate candidate diagnoses, to confirm most efficiently and effectively the diagnosis, or it can assist to arrive at a plan of treatment, or it can guide through a sequence of steps than need to be performed for treatment of a patient.

A DSS typically consists of two parts: a database that captures the, usually human, knowledge about the domain of interest and a reasoning system that provides means to explain and navigate through the stored knowledge. Typically, the knowledge can be phrased in the form of causality relationships: disorders cause symptoms, possibly through a concatenation of intermediate states. The model takes the form of a directed acyclic graph (DAG). For example, in the case of stroke, a vascular rupture or stenosis may cause a vascular occlusion, which in turn may lead to a cerebral lesion. Typically, as in this example, the causal relationships are not imperative, but have a likelihood associated with them.

An approach to implement a DSS is the use of Bayesian Networks (BN), see “Bayesian Networks and Decision Graphs”, by F. V. Jensen in Springer, 2001. A BN stores the joint probability distribution of all state values that the variables included in the model, i.e. the disorders, symptoms, etc., can assume. In order to do this efficiently, also leading to more efficient reasoning algorithms, the BN doesn't store the joint probability distribution itself, but stores the conditional probabilities of the variables' states, called the children, conditional on a well-chosen subset of the other variables' states, called the parents. Typically, the parent-child pairs in the BN correspond to the above-mentioned causality relationships.

A well-known problem with BN is the question what values are to be assigned to all, possibly conditional, probabilities in the network, see “Building Probabilistic Networks: Where Do the Numbers Come From?”, by M. J. Druzdzel and L. C. van der Gaag in Guest Editors' Introduction to special section of IEEE Transactions of Knowledge and Data Engineering, IEEE Trans. On Knowledge and Data Engineering 12(4), 2000. Typically, some of these values are known by human experts, in the form of imprecise linguistic expressions like “mostly”, “commonly”, “may happen”, etc., that are not quantified. Assigning exact probability numbers is a difficult task, certainly when aiming for a complete assignment of all the probabilities that the Bayesian network requires.

Another approach is to use machine learning techniques to distil the numbers from statistics, i.e. from (f)actual patient data. In this approach, practice has shown that the required data to train the network with, are not available, at least not in the required statistically reliable form to be of sufficient size to be statistically significant.

An embodiment of such a method is known from article “computer-based decision support in the management of primary gastric non-Hodgkin lymphoma” by Peter Lucas and Henk Boot and Babs Taal in “Methods of Information in Medicine 37, 1998, 206-219. Here, a decision-theoretic model of non-Hodgkin lymphoma of the stomach is described. Central to the model is a probabilistic network that describes a representation of the uncertainties underlying a decision-making process. The probabilistic network is a directed acyclic graph consisting of a set of nodes, representing discrete random variables, and a set of arcs, representing causal relationships or correlations among random variables. In order to model qualitative relationships, such as “good”, “average” and “poor” between the nodes into quantitative probabilities, the qualitative relations are modeled into qualitative probabilistic relationships by for example,
the probability that the general health status of a person in the age of 10 to 69 is good is larger than
the probability that the general health status of a person in the age of 10 to 69 is average which is larger than
the probability that the general health status of a person in the age of 10 to 69 is poor, i.e.:
Pr(general-health-status=good|age=10-69)>
Pr(general-health-status=average|age=10-69)>Pr(general-health-status =poor|age=10-69)

Then these probabilities are used to validate numerical values assigned to the causal relationships within the acyclic graph. This resulting probabilistic network is then used to determine the most probable disorder based upon an observed symptom. However, this approach restricts the use of the relative relationship to validating the numerical values.

It is an object of the invention to provide a system that directly uses the relative relationship between qualitative relationships in order to derive disorders for observed symptoms. To achieve this object, the invention provides a system according to the opening paragraph, the system comprising: a modeler for modeling qualitative relationships between disorders of the set of disorders and symptoms of the set of symptoms as a causal graph; an orderer for partially ordering the qualitative relationships; a determiner for using the observed symptom or set of symptoms to determine the subset of disorders for the observed symptom or set of symptoms in dependence of a subset of the qualitative relationships, the choice of which is based on the partial ordering of the qualitative relationships. By varying the choice of qualitative relationships, according to their partial ordering, the corresponding variation in the result sets of disorders for the observed symptoms can be used to compute the most probable disorder.

In an embodiment of the system according to the invention, the system further comprises a selector for interactive selection of the observed symptom and the set of disorders by a user. Herewith, the user can restrict the subset of disorders of the total set of disorders that may result from the observed symptom, which advantageously results in a faster response time of the system.

In a further embodiment of the system according to the invention, each of the qualitative relationships is associated with a likelihood level within the partial ordering of the qualitative relationships. By associating the likelihood level with the partial ordering, the system first uses the most likely qualitative relationships, and then includes less-likely qualitative relationships. This gives an improved subset of disorders for the observed symptom as it also includes disorders that are less likely for the observed symptom.

In a further embodiment of the system according to the invention, the determiner is further for changing the partial ordering of the qualitative relationships; and determining the subset of disorders for the observed symptom based upon the changed partial ordering. By changing the partial ordering, the system includes the uncertainty between the ordering of the qualitative relationships. For example “commonly” may be evaluated as more likely than “may happen” and the other way around.

In a further embodiment of the system according to the invention the determiner is further for determining a plurality of subsets of disorders from the set of disorders; and ranking the plurality of subsets of disorders by weighting the plurality of subsets of disorders. By determining a plurality of subsets, weighting them and ranking them accordingly, a user can better distinguish between the importance of the derived subsets of disorders for the observed symptoms.

In a further embodiment of the system according to the invention the determiner is further for restricting the subset of disorders for the observed symptom according to a predefined criterion. The predefined criterion may for example restrict to those disorders that are related by region in the body. An other example is to restrict properties of the relationships such as transitivity, the depth of the relationship, etc. In this way, the resulting subset of possible disorders is further improved.

It is an object of the invention to provide a medical workstation that uses the relative relationship between qualitative relationships in order to create a probabilistic network for disorders in an improved way. To achieve this object, the invention provides a medical workstation according to the opening paragraph, the medical workstation comprising: the system according to the invention; a database comprising a set of disorders, a set of symptoms, a model of qualitative relationships between disorders of the set of disorders and symptoms of the set of symptoms as a causal graph and a partial ordering the qualitative relationships; an interactive device for providing interaction between a user and the medical workstation. The medical workstation achieves this object in the same way as the corresponding system. Advantageously the interactive device enables the user to select and restrict the observed symptom and the possible set of disorders related to the observed symptom.

In an embodiment of the medical workstation according to the invention, the system, the database and the interactive device are located remotely from each other. By providing the subcomponents at different locations, each component can be serviced independently from the other subcomponents, which results in a more flexible configuration of the workstation.

It is an object of the invention to provide a method that uses the relative relationship between qualitative relationships in order to create a probabilistic network for disorders in an improved way. To achieve this object, the invention provides a method according to the opening paragraph, wherein qualitative relationships between disorders of the set of disorders and symptoms of the set of symptoms are modeled as a causal graph and the qualitative relationships are partially ordered, the method comprising using the observed symptom to determine the subset of disorders for the observed symptom based upon the partial ordering of the qualitative relationships. The method achieves this object in the same way as the corresponding system.

In an embodiment of the method according to the invention, the method further comprises interactively selecting the observed symptom and the set of disorders by a user. This embodiment gives the same advantages as the corresponding system.

It is an object of the invention to provide a computer program product that determines a subset of disorders in an improved way. To achieve this object, the invention provides a computer program product according to the opening paragraph, the computer arrangement comprising processing unit and a memory, the computer program product, after being loaded, providing said processing unit with the capability to carry out the task of using the observed symptom to determine the subset of disorders for the observed symptom based upon a partial ordering of qualitative relationships wherein the qualitative relationships between disorders of the set of disorders and symptoms of the set of symptoms are modeled as a causal graph and the qualitative relationships are partially ordered. The computer program product achieves this object in the same way as the corresponding system.

These and other aspects of the invention will be apparent from and elucidated with reference to the embodiments described hereinafter as illustrated by the following Figures:

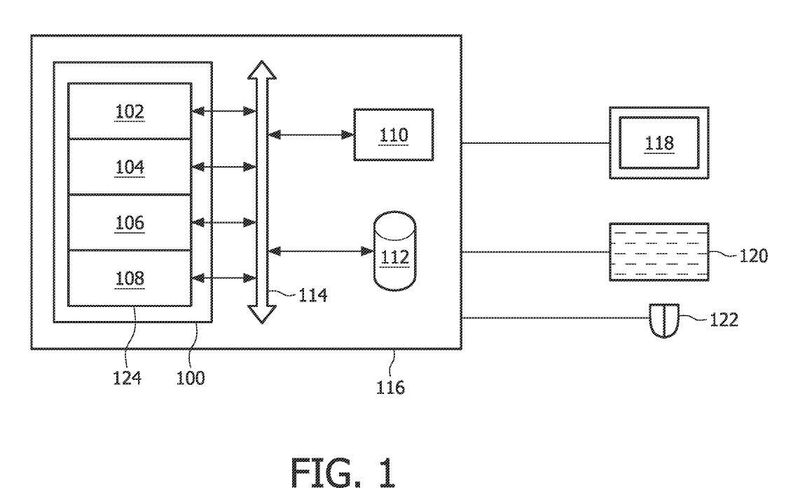

FIG. 1 illustrates a medical workstation including a system according to the invention in a schematic way;

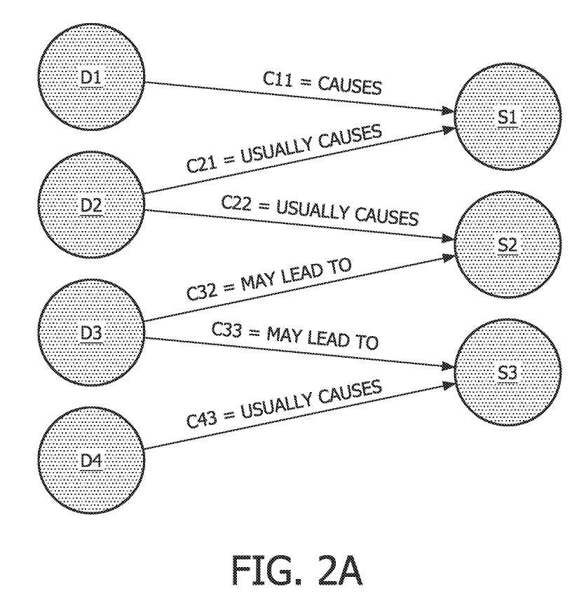

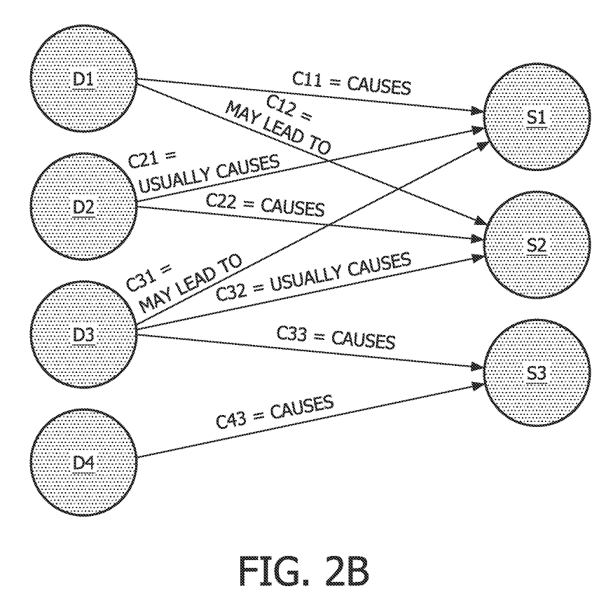

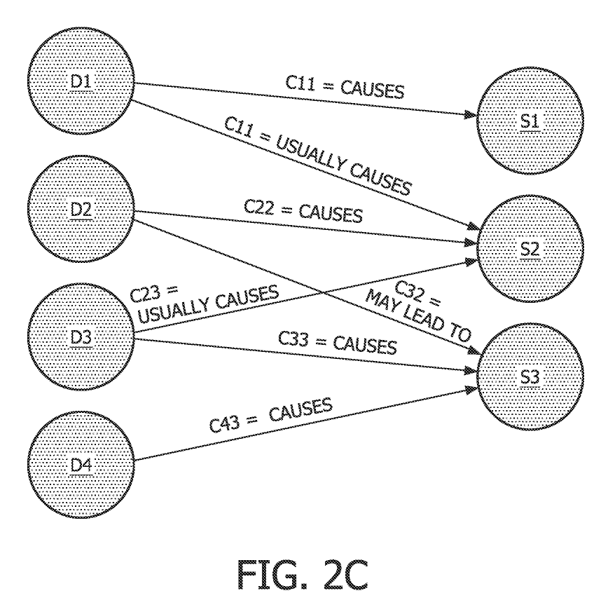

FIG. 2a illustrates an example graph to illustrate the system and method according to the invention;

FIG. 2b illustrates an example graph to illustrate the system and method where the size of a subset decreases when more links get added by moving to a next level;

FIG. 2c illustrates a further example graph to illustrate the system and method according to the invention of hiding and unhiding of a disorder;

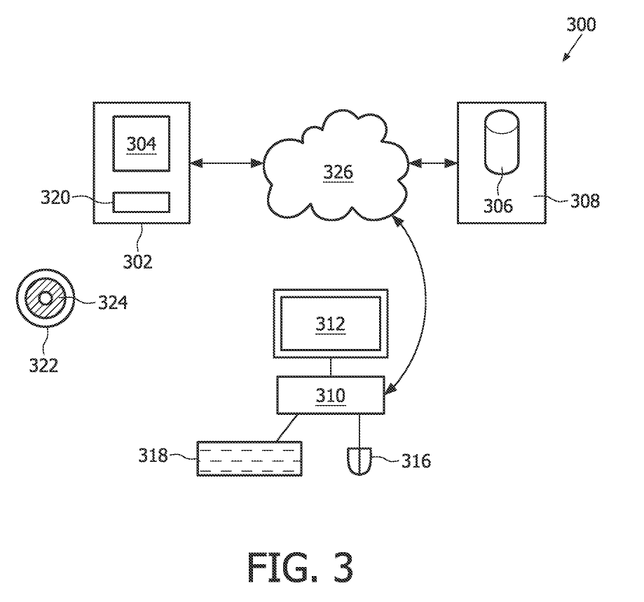

FIG. 3 illustrates a distributed configuration of the system and the workstation according to the invention in a schematic way.

FIG. 1 illustrates a medical workstation including a system according to the invention in a schematic way. The medical workstation 116 includes a display 118, a keyboard 120, a mouse 122, a microprocessor 110, a database 112, a software bus 114, and the system 100 according to the invention. The system 100 includes a modeler 102, an orderer 104, a determiner 106 and a selector 108. The modeler 102, the orderer 104, the determiner 106 and the selector 108 are implemented as computer readable software modules that are stored in memory 124. The memory 124 may be implemented as random access memory (RAM), loaded from main memory such as a hard disk or as read only memory (ROM) or as any other suitable memory designed to store computer readable software. The memory 124 including its computer readable software modules 102, 104, 106 and 108 are communicatively coupled to the database 112 and the micro processor 110 through software bus 114. The display 118, the keyboard 120 and the mouse 112 provide a user interactive communication with the computer readable software modules 102, 104, 106 and 108, the database 112 and the microprocessor 110 through input and output connectors (not shown).

The database 112 comprises a knowledge model about symptoms that a patient may exhibit, disorders that a patient may have that result in these symptoms, possibly through a concatenation of intermediate symptoms or disorders and a quantitative relationship between the symptoms and disorders. This quantitative relationship is described in terms of imprecise linguistic or unquantified expressions like “mostly”, “commonly”, “may happen”, “always causes”, “may lead to”, “usually causes” etc.

Below, the system is described while in operation to better explain how the computer readable software modules described above work together while the system is in operation.

The modeler 102 retrieves the knowledge model from the database 112 and models the symptoms and disorders as nodes of a causal graph wherein the arcs are determined by the quantitative relationship between the symptoms and disorders.

The orderer 104 determines a partial ordering between the quantitative relationships although the order itself may be uncertain, e.g. whether “mostly” is more likely than “commonly” may be either way. Each quantitative relationship in the graph is associated with some certainty or likelihood level in the partial order, resulting in an ordering of the arcs in a hierarchy. The hierarchy is preferably linear, i.e. a chain, but this is not required. Partial orders, which include lattice structures, are also allowed, for example.

The determiner 106 acts as a reasoner that returns all possible explanations, i.e. all subsets of disorders that cause an observed symptom or set of symptoms. A well-known algorithm that the determiner 106 uses for this purpose, for example, is described in “A formal model of diagnostic inference” by J. A. Reggia et al. in Information Sciences 37 (1985), 227-256, and ibid. pp. 257-285. This algorithm is applied iteratively, i.e. it is applied in multiple runs wherein in each run, more relationships are included. Instead of returning all possible explanations, variations thereof may also be returned. For example, returning all subsets that contain the smallest number of different disorders for the observed symptoms. Other algorithms may be used as well.

In order to use this algorithm, in each run quantitative relationships that adhere to a selection criterion used for the run, are treated as if they are imperative, i.e. they are True. For each run, the determiner 106 traverses the partial order and selects and deselects relationships to be imperative for each level in the partial order that may be traversed. The deselected relationships are treated as if they were not present, i.e. they are set to False. For each run, the resulting subset of disorders for the observed symptom is determined resulting in a plurality of resulting subsets. Advantageously, the resulting plurality of subsets may be combined by weighting them and taking a fuzzy set union. For example, the subsets that were determined when using the most certain relationship can be favored, i.e. weighted over the other determined subsets, or the subsets that appear the most can be favored, etc.

In other words, the determiner 106 distinguishes two phases. In the first phase, the algorithm is applied several times on the graph with the given set of observed symptoms, wherein in the first run only the most likely arcs are included to determine the subset of related disorders. In each subsequent run the arcs next in the likelihood hierarchy are added to the graph. The arcs included in the resulting subset of related disorders are treated with likelihood equal to one. Each subset of related disorders from each run is stored with a two place ranking label. Both places are initiated with the same value, namely that representing the level of the corresponding run in which they were generated. The label represents the position of its subset in the to-be-obtained hierarchy of subsets. As said, for simplicity, a linear order is assumed in the arc likelihood. If that's not the case, the label needs more places to reflect the (e.g., lattice) structure.

In the second phase the ranking labels are refined to obtain a final ranking of the found subsets. So, the starting position for this second phase is an ordered set of subsets of disorders that were derived by each run. Note, that the likelihood decreases with increasing link level, i.e. an arc, or relationship added at a higher level is less likely. Since the subset of related disorders at the highest-level yield the complete graph for the given knowledge model, this subset is taken as the answer set. This answer set is yet unranked. Note that it is possible that subsets found at lower levels do not appear in the answer set, since its effects have become hidden through a less likely arc being added at a higher level. At the lowest level in the link hierarchy it is possible that incomplete subsets will be given. Not all observations can be explained, since the observations concerned are not caused through an arc with the largest likelihood. Obviously, subsets will become complete when adding more arcs. Another effect that may happen when adding links is a decrease in the typical size of the subsets. The new subset can be a new alternate but it can also be a strict subset of an earlier subset at a lower level. The subset can explain the observations through the additional causal link. The reduction in size can be a decrease in the minimum cardinality of the subsets or the loss of parsimony of a subset.

A removed disorder can either remain as member in an alternate subset, or can become a hidden disorder. A hidden disorder is a disorder that is relevant because some of its effects are in the observation set while it is redundant in all subsets because it cannot serve as alternate to the disorders in any subset of related disorders. Hidden disorders can already exist at the first level of the hierarchy. Also, the other way around, disorders that are hidden at a certain level can become unhidden at a higher level.

The ranking of the answer set, i.e. the subsets of related disorders at the highest level, is performed in the following way. Initially the hierarchy of subsets is taken where each subset is labeled with the threshold level at which the subset was computed, then the following steps are performed:
assign to each subset the level of the subsets' first appearance;
remove duplicate subsets from the previous level;
assign to each element in each subset the level of the element's first appearance;

order the subsets according to their rank, i.e. the level of the subsets' first appearance, within which [within which?] smallest cardinality is ranked first;
within this order, order the sets of equal rank according to the rank of the last element that appeared in the set. If the likelihood of these elements are equal, repeat with the next last element.

In case an answer is a reduced-size subset of which the removed disorder is a hidden disorder, the subset at the lower level is reintroduced in the answer set. It is ranked with the likelihood of the lower level, however, with a mark that indicates its redundancy at the lower likelihood, i.e. at the higher level. Remaining hidden disorders are listed separately to the answer set. Since they are hidden, but relevant, they are redundant to any of the subsets of related disorders in the answer set.

In summary, the final ranking hierarchy evolves as follows. Subsets are ordered according to first appearance. Subsets with an identical first appearance rank, are ranked according to the last first-appearance of its elements. Further, they are ordered according to their size, smaller cardinality first.

The selector 108 uses the resulting subsets of disorders, i.e. the answer set, to present them to a user through display 118. The user may then use the resulting subsets of disorders as an aid in order to determine a diagnosis for a patient.

The above is explained by the following examples.

FIGS. 2a, 2b and 2c illustrate an example graph to illustrate the system and method according to the invention. FIGS. 2a, 2b and 2c depict a graph representing the causal knowledge between disorders and symptoms. D1 to D4 are disorders, S1 to S3 are symptoms, and C11 to C43 are causal links. The causal links are ordered according to the indicated likelihood, i.e. CAUSES is more likely than USUALLYCAUSES which is more likely than MAYLEADTO:
CAUSES [symbol] USUALLYCAUSES [symbol] MAYLEADTO

The system and method derive those subsets of disorders that explain all of the observed symptoms, in the following way:
the causal knowledge is modeled as follows:

S1=(D1 and C11) or (D2 and C21) (1)

S2=(D2 and C22) or (D3 and C32) (2)

S3=(D3 and C33) or (D4 and C43) (3)

i.e.
(1) indicates that symptom S1 can be derived from disorder D1 and relationship C11 or from disorder D2 and relationship C21;
(2) indicates that symptom S2 can be derived from disorder D2 and relationship C22 or from disorder D3 and relationship C32;
(13) indicates that symptom S3 can be derived from disorder D3 and relationship C33 or from disorder D4 and relationship C43.

FIG. 2a illustrate an example method to derive a set of disorders for the observed set of symptoms. In the first phase, the subsets of related disorders sets are computed for incrementally added links. In the first run C11 (likelihood CAUSES) is set to True and all other Cij to False. In the second run C21, C22 and C43 (likelihood USUALLYCAUSES) are added. In the third, final, run C32 and C33 (likelihood MAYLEADTO) are added. This leads to the following sets of explanation sets:
level 3: {{D1, D3}, {D2, D3}, {D2, D4}}
level 2: {D2, D4}
level 1: {{D1}} (S2; S3 unexplained)

That is, in the first run (level 1), only S1 is explained by {D1}. In the second run (level 2), only the set {D2, D4} explains all symptoms S1, S2, and S3 and in the final run (level 3), the sets {D1, D3}, {D2, D3}, and {D2, D4} explain all symptoms.

Next, in the second phase, the ranking is assigned. The answer set that consists of the explanation sets at level 3:
{D1, D3}, {D2, D3}, {D2, D4}}are initiated with rank 3, from level 3. The set {D2, D4} appears for the first time at level 2. Hence, that set is reassigned with rank 2. Next, to each element in each explanation its level of first appearance is assigned. This yields the following labeling of ranks:
rank 3: {D1[1], D3[3]}, {D2[2], D3[3]}
rank 2: {D2[2], D4[2]}
rank 1:

Set {D1} is removed as it does not explain all observed symptoms. For all explanations the cardinality is 2, so there is no ranking on cardinality. At rank 2 a first explanation arises. Hence this explanation will become rank 1 in the final order. At rank 3, the last-appeared element (D3) appeared at level 3, but the next last-appeared elements (D1 and D2) appeared at level 1 and level 2 respectively. This yields the following final sets of disorders:
rank 3: {D2, D3}
rank 2: {D, D3}
rank 1: {D2, D4}

FIG. 2b gives an example where the size of a subset decreases when more links get added by moving to a next level. At the first level only links C11, C22, C33, and C43 (likelihood CAUSES) are set to True. The explanation consists of two alternates:
{D1, D2, D3} and {D1, D2, D4}

At the next level, links C21 and C32 (likelihood USUALLYCAUSES) are added, and the explanation changes into three alternates:
{D1, D3}, {D2, D3}, and {D2, D4}, wherein all three are a subset of the explanations found at the first level. At the next and final level, links C12 and C31 (likelihood MAYLEADTO) are added, and the explanation changes into again three alternates:
{D3}, {D1, D4}, and {D2, D4}, wherein {D1 , D4} is an example of a new alternate, {D3} is a subset of minimum cardinality, namely 1. {D1 , D4} and {D2, D4} are examples of subsets of which the superset, {D1 , D2, D4}, lost its parsimony. {D1, D2, D4} also provides an explanation, but D1 can be removed without making the explanation incomplete. Removal of either combination of D1 or D2 with D4 would make the remaining explanation incomplete, and hence {D1 or D2 , D4} is a parsimonious explanation. It is not minimal, since its cardinality is 2 instead of 1 (for {D3}).

FIG. 2c gives an example of hiding and unhiding of a disorder. As before, at the first level links C11, C22, C33, and C43 (likelihood CAUSES) are set to True, and the explanation consists of the two alternates:
{D1, D2, D3} and {D1, D2, D4}

Now, at the next level, links C11 and C23 (likelihood USUALLYCAUSES) are added, and the explanation changes into two alternates:
{D1, D3} and {D1, D4}.

Next to a reduction in cardinality, D2 has become hidden. At the third level C32 (likelihood MAYLEADTO) gets added, which provides an example where a disorder, D2 in this case, becomes unhidden. At this third level, the explanation set consists of three alternates:
{D1, D2}, {D1, D3}, and {D1, D4}.

It should be noted that the presented algorithm is by way of example. Heuristics of similar nature can be used instead to arrive at or refine the eventual ranking.

The inventive concept can be refined in several ways. An advantageous one is to apply (in addition) the (interactive) selection on the disorder and symptom space itself. For example, the explanations can be queried while excluding an observed symptom that is known/suspected to dominate the others. In this way, secondary disorders might become visible to the physicians. Another example is to query for those disorders that are related somehow. For example, to only select the disorders that are located in the chest region of the body, or that are close (in terms of the anatomy) to the heart. One could also think of selecting disorders and symptoms based on holistic disease models.

Another refinement is to select/deselect properties of the relationships. For example, a relationship can be treated transitive or not. This will discriminate between disorders that can be directly responsible for a symptom and those that require intermediate phases/states. A variation is to select the depth of (in)direction. A convenient way to implement the selection process is to make use of description logic (DL), see “The description logic handbook” by F. Baader, D. Calvanese, D. L. Mc Guinness, D. Nardi, P. F. Patel-Schneider in Cambridge University Press, 2003. DL allows to model class and relationship hierarchies and to reason with them, e.g. to decide whether one class expression is subsumed by another, possibly in the context of some given background knowledge. By using such a formalism as DL it is not required that the class expressions are literally corresponding. For example, when selecting for disorders in the heart region, one could add a DL constraint “located.heartRegion” to the disorder class, while it is not required that the disorders in the DSS are labeled literally with “location heart region”. Another example, in case of a stenosis or occlusion in an artery is to constrain for those disorders that are “located.UpStream” of an observed lesion. It suffices that the labeled location including the labeling mechanism itself, can be traced to the query form within the logic formalism. The DL provides flexibility to the selection process. The DL classes and relationships are linked to the dependency graph (DAG) in the following way. The dependency graph describes disorders, intermediate states, symptoms, etc., and how one causes, may cause, etc., the other. The nodes in the graph (disorders, intermediate states, symptoms, etc.) are treated as individuals (class members) in the DL, while the edges are treated as roles (relationships) in the DL. So, the graph is viewed as a dependency network when operating the system according to the invention, while it is viewed as “tableau” when operating the DL reasoning mode. A tableau is the widely-used representation form for implementing DL inference tasks, like deciding subsumption, satisfiability, consistency, and retrieval.

Yet an other refinement is to enable a user to restrict the disorders that may cause the observed symptom. Hereto, the medical workstation 116, see FIG. 1 provides the user with a user interface displayed by display 118 to present the graph. The user may then operate the keyboard 120 and/or the mouse 122 to select those nodes of disorders in the graph that may cause the observed symptom. The not-selected disorders may then be omitted while determining the subset of possible disorders, i.e. the result set.

FIG. 3 illustrates a distributed configuration of the system and the workstation according to the invention in a schematic way. The distributed configuration 300 comprises a first general-purpose computer 302 that acts as a server and a second general purpose computer 308 that acts as an other server. The computer 302 comprises the system 304 according to the invention while the computer 308 comprises the database 306 that holds the knowledge model. Such a knowledge model may be distributed and may also comprise an ontology of the anatomy of a human. The first general-purpose computer 302 further comprises a disk drive operable to receive a corresponding computer readable medium such as a DVD disk 322. The DVD disk 322 comprises computer readable code designed to provide the system 100, after being loaded, with the corresponding software modules as described above with reference to the system according to the invention. The distributed configuration 300 further comprises medical workstation 310 that comprises a display 312, a mouse 316, a keyboard 318, and a general-purpose computer 314 that acts as a client of servers 302 and 308. The medical workstation, the system 304 and the database 306 communicate with each other over the internet to exchange the requested information.

It should be noted that the above-mentioned embodiments illustrate rather than limit the invention, and that those skilled in the art will be able to design many alternative embodiments without departing from the scope of the appended claims. Especially heuristics of similar nature can be used instead to arrive at or refine the eventual ranking of the disorders.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the system claims enumerating several means, several of these means can be embodied by one and the same item of computer readable software or hardware. The mere fact that certain measures are recited in mutually different dependent claims does not indicate that a combination of these measures cannot be used to advantage.

1. System (100, 304) for determining a subset of disorders of a set of disorders for an observed symptom of a set of symptoms, the system comprising:
a modeler (102) for modeling qualitative relationships between disorders of the set of disorders and symptoms of the set of symptoms as a causal graph;
an orderer (104) for partially ordering the qualitative relationships;
a determiner (106) for using the observed symptom to determine the subset of disorders for the observed symptom based upon the partial ordering of the qualitative relationships.

2. A system according to claim 1, further comprising:
a selector (108) for interactive selection of the observed symptom and the set of disorders by a user.

3. A system according to 1, wherein each of the qualitative relationships is associated with a likelihood level within the partial ordering of the qualitative relationships.

4. A system according to claim 1, wherein the determiner is further for
changing the partial ordering of the qualitative relationships; and
determining the subset of disorders for the observed symptom based upon the changed partial ordering.

5. A system according to claim 1, wherein the determiner is further for
determining a plurality of subsets of disorders from the set of disorders; and
ranking the plurality of subsets of disorders by weighting the plurality of subsets of disorders.

6. A system according to claim 1, wherein the determiner is further for restricting the subset of disorders for the observed symptom according to a predefined criterion.

7. A medical workstation (116) for determining a subset of disorders of a set of disorders for an observed symptom of a set of symptoms, the medical workstation comprising:
the system (100, 304) according to claim 1;
a database (112, 306) comprising a set of disorders, a set of symptoms, a model of qualitative relationships between disorders of the set of disorders and symptoms of the set of symptoms as a causual graph and a partial ordering the qualitative relationships;
an interactive device (118, 120, 122) for providing interaction between a user and the medical workstation.

8. A medical workstation according to claim 7, wherein the system, the database and the interactive device are located remotely from each other.

9. A method of determining a subset of disorders of a set of disorders for an observed symptom of a set of symptoms, wherein qualitative relationships between disorders of the set of disorders and symptoms of the set of symptoms are modeled as a causal graph and the qualitative relationships are partially ordered, the method comprising:
using the observed symptom to determine the subset of disorders for the observed symptom based upon the partial ordering of the qualitative relationships.

10. A method according to claim 9, further comprising:
interactively selecting the observed symptom and the set of disorders by a user.

11. A computer program product (324) to be loaded by a computer arrangement (116), comprising instructions for determining a subset of disorders of a set of disorders for an observed symptom of a set of symptoms, the computer arrangement comprising processing unit (110) and a memory (124), the computer program product, after being loaded, providing said processing unit with the capability to carry out the task of using the observed symptom to determine the subset of disorders for the observed symptom based upon a partial ordering of qualitative relationships wherein the qualitative relationships between disorders of the set of disorders and symptoms of the set of symptoms are modeled as a causal graph and the qualitative relationships are partially ordered.
